(19) United States
(12) Patent Application Publication
(10) Pub. No.: US 2025/0135643 A1
(43) Pub. Date: May 1, 2025

(54) System and Method for Manipulating Deformable Objects

(71) Applicant: Northeastern University, Boston, MA (US)

(72) Inventors: Taskin Padir, Westborough, MA (US); Nathaniel Hanson, Boston, MA (US); Sebastian Vig Wicke, Oakland, CA (US); Austin Nilo Allison, Boston, MA (US)

(21) Appl. No.: 18/933,478

(22) Filed: Oct. 31, 2024

Related U.S. Application Data
(60) Provisional application No. 63/595,017, filed on Nov. 1, 2023.

(51) Int. Cl. B25J 9/16; B25J 9/00; B25J 11/00; B25J 13/08; B25J 17/02

(52) U.S. Cl. CPC B25J 9/1664; B25J 9/0009; B25J 9/1633; B25J 9/1653; B25J 11/0045; B25J 13/085; B25J 13/088; B25J 17/0283

(57) ABSTRACT

A system, method, and means for manipulating deformable objects are provided. The system may comprise a baseplate and at least one appendage actuation module configured to mount on the baseplate. The at least one appendage actuation module may include an appendage of rigid and elongate construction, a platform, and at least one actuation device. The at least one actuation device may be in coupled arrangement with the appendage and the platform to cause the appendage to move in at least three degrees-of-freedom, at least including an axis of linear translation and an axis of rotation, with respect to the baseplate. The at least one appendage actuation module may be capable of actuating the appendage with sufficient force to manipulate the deformable objects along a plurality of degrees of motion, at least including three axes of rotation. Embodiments may be useful for robotic automation in food processing or assistive technologies.

### RELATED APPLICATION(S)

This application claims the benefit of U.S. Provisional Application No. 63/595,017, filed on Nov. 1, 2023. The entire teachings of the above application are incorporated herein by reference.

### GOVERNMENT SUPPORT

This invention was made with government support under 1928654 from the National Science Foundation. The government has certain rights in the invention.

### BACKGROUND

Manipulating deformable objects using robotic systems may be useful for a broad range of applications, including but not limited to industrial seafood processing, food inspection, food packing, or at-home meal-assistance. Deformable object manipulation is a challenging task in robotics. Existing robotic end effectors that can perform manipulation of deformable objects often feature multiple articulated joints in fingers or employ active surfaces to achieve desired levels of control. Such approaches, however, are typically mechanically complex and difficult to adopt in food processing settings where food safety is paramount. Alternative approaches include soft grippers, which may be underactuated and unable to reposition items in-grasp. Developing mechanically simple, dexterous, and gentle systems for manipulating deformable objects, for example food items, may be useful for the adoption of robotic systems as assistive devices.

### SUMMARY

According to an example embodiment of a system for manipulating deformable objects, the system may comprise a baseplate and at least one appendage actuation module configured to mount on the baseplate. The at least one appendage actuation module may include an appendage of rigid and elongate construction, a platform, and at least one actuation device, the at least one actuation device in coupled arrangement with the appendage and the platform to cause the appendage to move in at least three degrees of freedom, at least including an axis of linear translation and an axis of rotation, with respect to the baseplate. The at least one appendage actuation module may be capable of actuating the appendage with sufficient force to manipulate the deformable objects along a plurality of degrees of motion, the plurality of degrees of motion at least including three axes of rotation.

The at least one actuation device may include a linear actuation device, a rotation actuation device, a spherical actuator, another actuation device, or a combination thereof. The at least one actuation device may also be not more in number than a number of degrees-of-freedom of movement of the appendage with respect to the baseplate.

The system may further include a spherical joint linkage statically coupled with the platform. The appendage may be coupled mechanically with the spherical joint linkage and the at least one actuation device may be configured cause the appendage to pivot around a point internal to the spherical joint linkage. The at least one actuation device may include a rotation actuation device and a horn, the horn coupled mechanically with the rotation actuation device and configured to cause the appendage to pivot around the point internal to the spherical joint linkage. The horn and the appendage may be coupled mechanically using at least one ball joint linkage or ball head buckle linkage.

At least a portion of the appendage may be configured to be detachable. The baseplate may further include coupling members, the coupling members configured to mount the baseplate onto a mechanical, robotic, or biological apparatus.

The system may further comprise at least one sensor configured to detect a corresponding property of the at least one appendage during operation. The at least one sensor may include a position sensor configured to detect a position state of the at least one actuator during operation of the system. The at least one sensor may also include a force-torque sensor, the force-torque sensor configured to couple mechanically with the appendage and to detect a force applied to the appendage. The system may additionally comprise a processor configured to compute a current position of the appendage and an end position of the appendage based on properties detected, to compute operations for the least one actuator to move the appendage from the current position computed to the end position computed, and to cause the at least one actuator to move the appendage based on the operations computed.

The deformable objects may be food items.

According to another example embodiment, a method for manipulating deformable objects comprises causing at least one appendage, mechanically coupled to a baseplate, a platform, and at least one actuator, to move in at least three degrees-of-freedom, at least including an axis of linear translation and an axis of rotation, with respect to the baseplate. The method may further comprise positioning the at least one appendage to manipulate the deformable object along a plurality of degrees of motion, the plurality of degrees of motion at least including three axes of rotation.

Manipulating deformable objects may include grasping, pinching, rotating, scooping, lifting, or other operations. The method may further comprise concurrently transporting and manipulating the deformable objects.

The method may further comprise sensing properties of the appendage. The method may still further comprise operating the at least one actuation device based on the properties sensed in a closed feedback loop. The method may also further comprise grading the deformable objects based on the properties sensed, wherein grading includes evaluating the size, weight, hardness, or other characteristics of the deformable objects.

Positioning the at least one appendage may include computing a position of the at least one appendage based on the properties sensed using an inverse kinematic model for a plurality of actuators.

The method may further comprise positioning concurrently a plurality of appendages to manipulate the deformable object.

According to another example embodiment, a system for manipulating deformable objects may comprise means for enabling at least one appendage, mechanically coupled to a baseplate, a platform, and at least one actuator, to move in at least three degrees-of-freedom, at least including an axis of linear translation and an axis of rotation, with respect to a baseplate. The system may further comprise means for positioning the at least one appendage to manipulate the deformable object along a plurality of degrees of motion, the plurality of degrees of motion at least including three axes of rotation.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an illustration of an example embodiment of a robot with a system for manipulating deformable objects configured to mount on a co-robot.

FIG. 2 is an isometric diagram of an example embodiment of a system for manipulating deformable objects.

FIG. 3 is an exploded diagram of an example embodiment of an appendage actuation module of a system for manipulating deformable objects.

FIG. 4 is an exploded diagram of an example embodiment of an appendage of a system for manipulating deformable objects.

FIG. 5A is an isometric diagram of an example embodiment of a spherical interaction of an appendage actuation module positioned in-plane with respect to a reference frame.

FIG. 5B is a diagram of the reference frame of FIG. 5A and parameters derived thereof.

FIG. 5C is a cross-sectional view of the spherical interaction of FIG. 5A.

FIG. 6A is an isometric diagram of an example embodiment of a spherical interaction of an appendage actuation module positioned out-of-plane with respect to a reference frame.

FIG. 6B is a cross-sectional view of the spherical interaction of FIG. 6A.

FIG. 7A is a plot of an example embodiment of positions commanded versus positions observed of an appendage of a device for manipulating deformable objects.

FIG. 7B is a plot of pose error of the respective positions commanded versus positions observed of the appendage of FIG. 7A.

FIG. 8A is a plot of an example embodiment of force measurements from striking objects of varying shore hardness with an appendage.

FIG. 8B is a plot of an example embodiment of torque measurements from striking objects of varying shore hardness with an appendage.

FIG. 9 is a compilation of example applications of a system for manipulating deformable objects, including a variety of food items.

### DETAILED DESCRIPTION

A description of example embodiments follows.

An example embodiment of the present invention draws inspiration from numerous cultures that use chopsticks to manipulate skillfully a wide array of foods without damaging the foods, including highly-deformable items, such as sushi. Chopstick-like appendages, when used as grippers, may be able to close on something as small as a bean or a single grain of rice but still open up large enough to support a banana laid across the chopstick-like appendages, similar to a forklift.

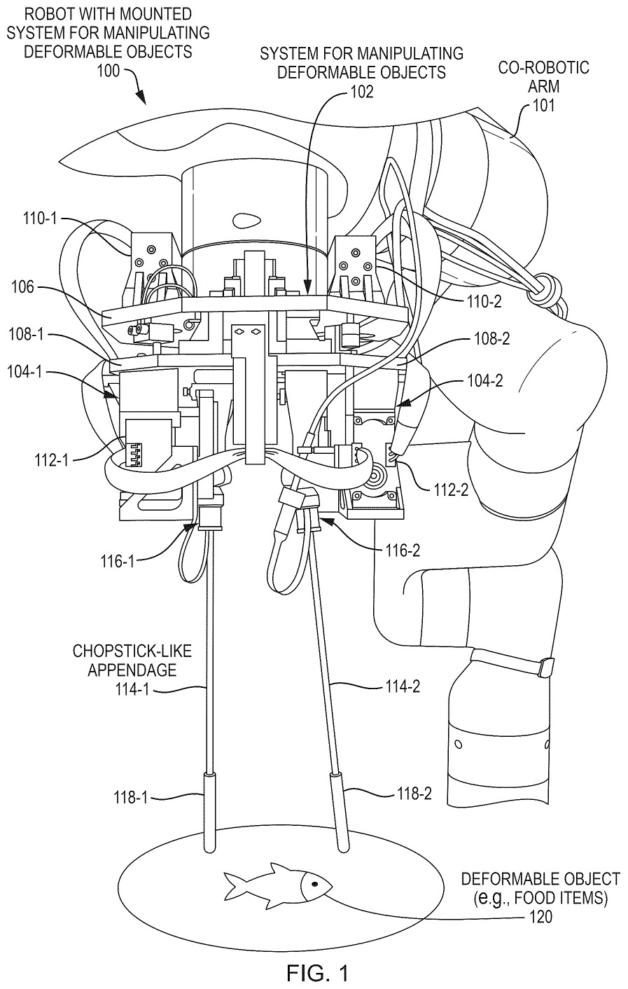

FIG. 1 is an illustration of an example embodiment of a robot 100 comprising a system 102 for manipulating deformable objects 120 configured to mount on a co-robotic arm 101. In this embodiment, the system comprises a baseplate 106 and at least one appendage actuation module 104-1, 104-2 configured to mount on the baseplate 106. The at least one appendage actuation module 104-1, 104-2 may include an appendage 114-1, 114-2 of rigid and elongate construction, a platform 108-1, 108-2, and at least one actuation device 110-1, 110-2, 112-1, 112-2. The appendage may be, for example, a chopstick or another utensil. The at least one actuation device 110-1, 110-2, 112-1, 112-2 may be in coupled arrangement with the appendage 114-1, 114-2 and the platform 108-1, 108-2 to cause the appendage 114-1, 114-2 to move in at least three degrees-of-freedom (DOF), at least including an axis of linear translation and an axis of rotation, with respect to the baseplate. The at least one appendage actuation module 104-1, 104-2 may be capable of actuating the appendage 114-1, 114-2 with sufficient force to manipulate deformable objects 120 along a plurality of degrees of motion, the degrees of motion at least including three axes of rotation.

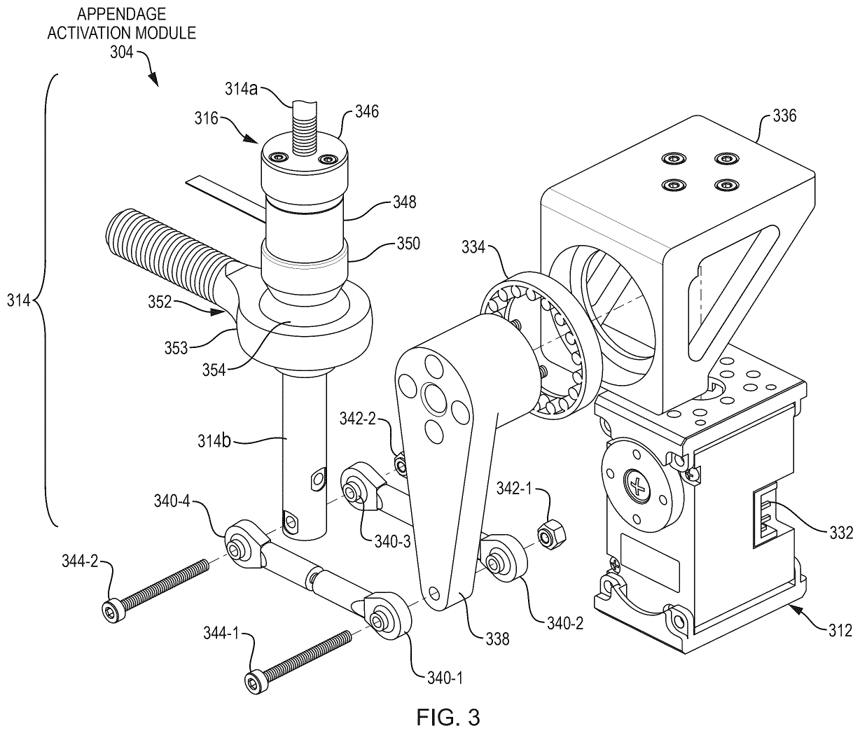

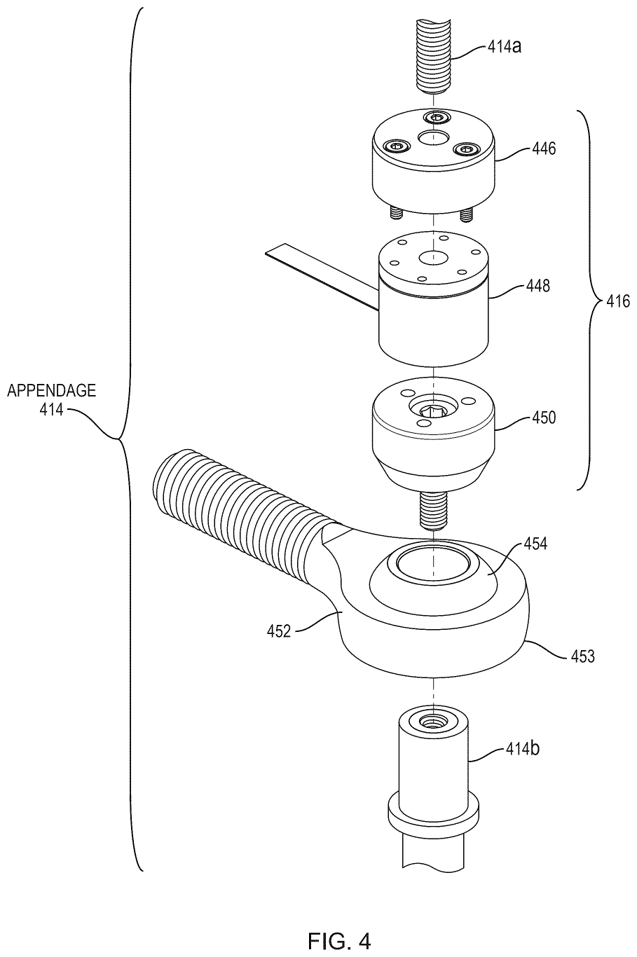

In example embodiments of a system similar to the system 102, the appendage 114-1, 114-2 may be configured as grippers. The appendage 114-1, 114-2 may be constructed from various materials, such as inexpensive aluminum, and may be easily removed and replaced, for example, by affixing the appendage 114-1, 114-2 using a screw mechanism as shown at least in reference to FIGS. 3 and 4. The replaceability of the appendage may be useful for cleaning or sterilization and for deploying the system 102 in settings with a risk of cross-contamination.

In some embodiments, the at least one appendage actuation module 104-1, 104-2 may be configured to operate independently of other appendage actuation modules 104-1, 104-2. In further embodiments, a system may include additional appendage actuation modules, for example, three or four appendage actuation modules configured to mount on the baseplate 106. Using additional appendage actuation modules may provide improved stability and grip when manipulating deformable objects.

The system 102 for manipulating deformable objects may include linear actuation devices 110-1, 110-2 to cause the appendage 114-1, 114-2 to move along an axis of linear translation and may include rotation actuation devices 112-1, 112-2 to cause the appendage 114-1, 114-2 to move along an axis of rotation. Optionally, the system 102 may include sensor units 116-1, 116-2 mechanically coupled to the appendage 114-1, 114-2 to sense forces applied to the appendage 114-1, 114-2. The appendage may also include a replaceable cover 118-1, 118-2, e.g., a rubber tip cover.

In some example embodiments, the rotation actuation devices 112-1, 112-2 may include rotation servomotors, which may include a rotation actuator and a sensor for determining a rotation position of the rotation actuator. In other example embodiments, the linear actuation devices 110-1, 110-2 may include linear servomotors, which may include a linear actuator and a sensor for determining a linear position of the linear actuator. The rotation actuation devices 112-1, 112-2 and linear actuation devices 110-1, 110-2 may be operatively coupled with a processor, the processor commanding the rotation actuation devices and linear actuation devices to cause the appendage 114-1, 114-2 to move into a desired position. The processor may further use sensor information from the rotation servomotors or the linear servomotors to determine a position of the appendage 114-1, 114-2.

Example embodiments similar to the system 102 of FIG. 1 may be configured to act as an end effector of the co-robotic arm 101. In such embodiments, the baseplate 106 of the system 102 may further include coupling members, the coupling members configured to mount the baseplate onto a mechanical appendage, a robotic appendage, e.g., the co-robotic arm 101, a biological appendage, or other similar devices.

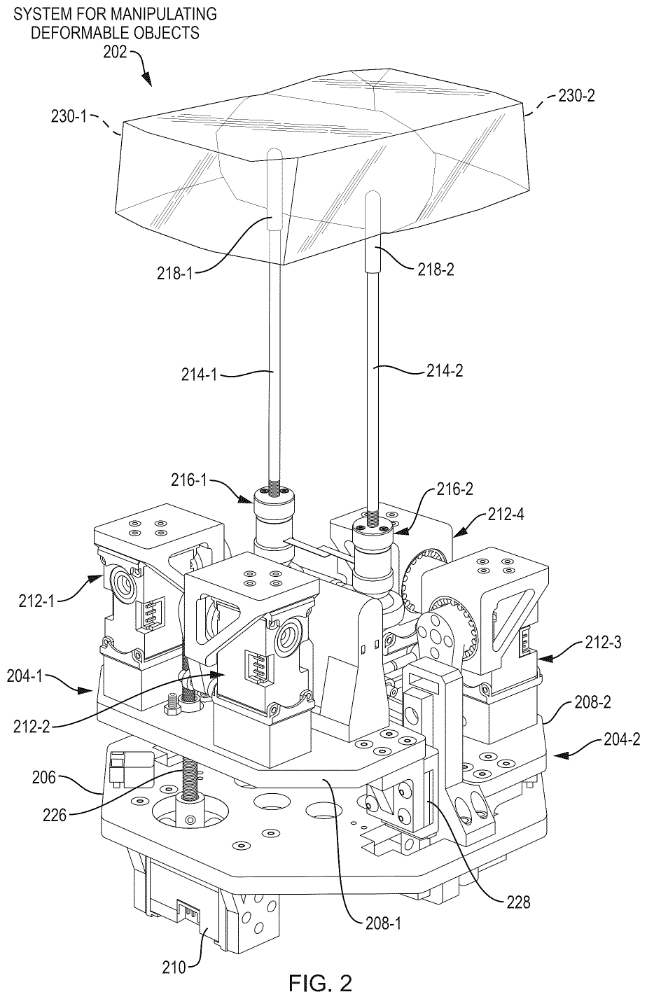

FIG. 2 is an isometric diagram of an example embodiment of a system 202 for manipulating deformable objects similar to the system 102 of FIG. 1. Continuing with reference to FIG. 2, in this embodiment, the system 202 comprises a baseplate 206 and at least one appendage actuation module 204-1, 204-2. The at least one appendage actuation module 204-1, 204-2 may include an appendage of rigid and elongate construction 214-1, 214-2, a platform 208-1, 208-2, and at least one actuation device. The at least one actuation device may be in coupled arrangement with the appendage 214-1, 214-2 and the platform 208-1, 208-2 to cause the appendage 214-1, 214-2 to move in at least three DOF, at least including an axis of linear translation and an axis of rotation, with respect to the baseplate 206. A convex hull 230-1, 230-2 indicates the reachable positions of the respective appendages 214-1, 214-2.

The at least one actuation device may include linear actuation devices 210 and rotation actuation devices 212-1, 212-2, 212-3, 212-4. The linear actuation devices 210 may be coupled mechanically with a lead screw 226 and a linear axis rail 228, the linear axis rail coupled statically to the baseplate 206 and coupled mechanically to the platform 208-1, to cause the translation of the platform 208-1 with respect to the baseplate 206.

FIG. 3 is an exploded diagram of an example embodiment of an appendage actuation module 304 of a system for manipulating deformable objects. The appendage actuation module 304 may be similar to the appendage actuation module 204-1, 204-2 of FIG. 2. Continuing with reference to FIG. 3, the appendage actuation module includes an appendage 314 and a rotation actuation device 312. The rotation actuation device 312 may include a rotation actuator 332 and a horn 338. The horn 338 may be coupled mechanically with the rotation actuator 332, the rotation actuator 332 causing the horn 338 to rotate around an axis of the rotation actuator 332. The rotation of the horn 338 may also cause the appendage to move along an axis of rotation. A slop reducer 336 and ball bearings 334 may be used to couple the horn 338 to the rotation actuator 332 to reduce imprecise motions of the horn 338 due to slop. The horn may be coupled to the appendage 314, for example, to a backend of the appendage 314b, using at least one ball joint linkage, e.g., ball head buckle linkages 340-1, 340-2. The ball head buckle linkages 340-1, 340-2 may be configured to fasten to the horn and to the appendage, for example, fastening using fastener screws 344-1, 344-2 and nuts 342-1, 342-2.

The appendage 314 may include the backend 314b, a sensor unit 316, and a frontend 314a. The sensor unit 316a may include a sensor mount 350, a sensor 348, for example, a force-torque sensor, and a sensor-appendage interface 346. Furthermore, the appendage may be coupled mechanically with a spherical joint linkage 352, the spherical joint linkage 352 including a socket 353 and spherical joint 354, to enable the appendage 314 to pivot around a point internal to the spherical joint linkage 352. The rotation actuation device 312 may be configured to cause the appendage 314 to pivot around the point internal to the spherical joint linkage 352. The appendage 314 may also be configured to couple with additional actuation devices (not shown). Furthermore, at least a portion of the appendage 314, for example, the frontend 314a, may be configured to be detachable to facilitate replacement of the portion of the appendage.

FIG. 4 is an exploded diagram of an example embodiment of an appendage 414 of a system for manipulating deformable objects. The appendage 414 may be similar to the appendage 314 of FIG. 3. Continuing with reference to FIG. 4, the appendage 414 may include a frontend 414a, a sensor unit 416, and a backend 414b. The appendage may be configured to couple to a spherical linkage with a socket 452 and a spherical joint 454 and to pivot around a point internal to the spherical joint 454. The sensor unit 416 may include an appendage-sensor interface 446, a sensor 448, e.g., a force-torque sensor, and a sensor mount 450. The sensor unit may be configured to couple mechanically with the appendage 414.

The sensor 448 of the sensor unit 416 may include a force-torque sensor. The use of a force/torque sensor may provide tactile feedback of forces applied to an appendage, for example, the appendage 414, which may be useful for manipulating deformable objects, including food items, that are easily damaged. The force/torque sensor may include a 6-axis force/torque sensor and may have a measurement range of ±25 N force and ±135 mNm torque.

In some embodiments of a system for manipulating deformable objects, a processor may be configured to couple with a sensor to accept measurements from the sensor. The measurements, for example, force readings from a force/torque sensor, may be used in the grading of food or as part of a feedback loop for controlling the appendages. In other embodiments, the force/torque may be omitted as a cost-saving measure.

### Inverse Kinematics for Appendage Positioning

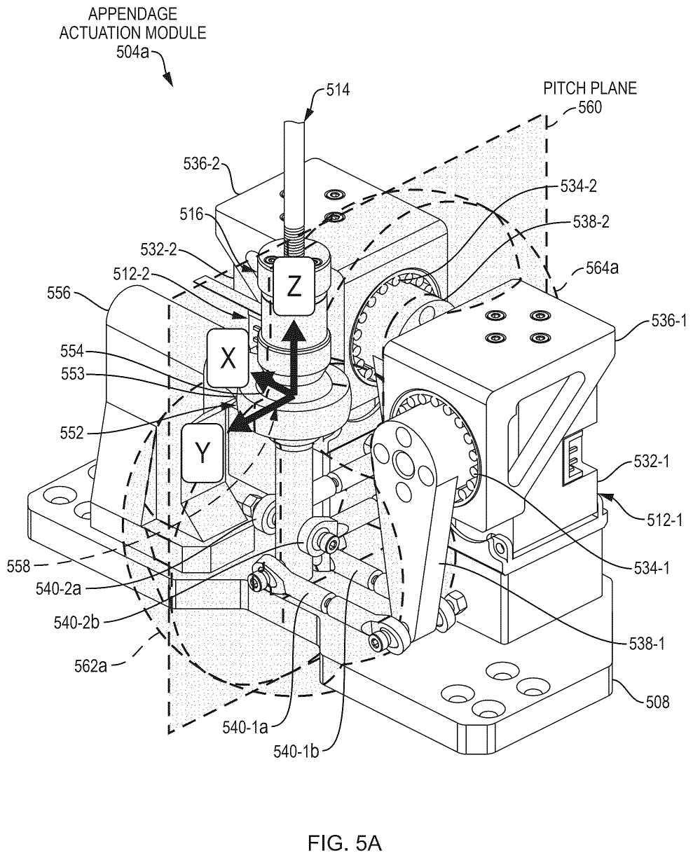

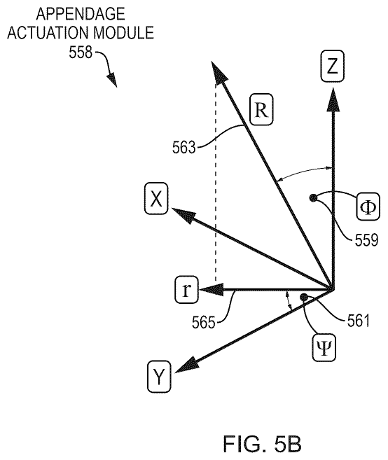

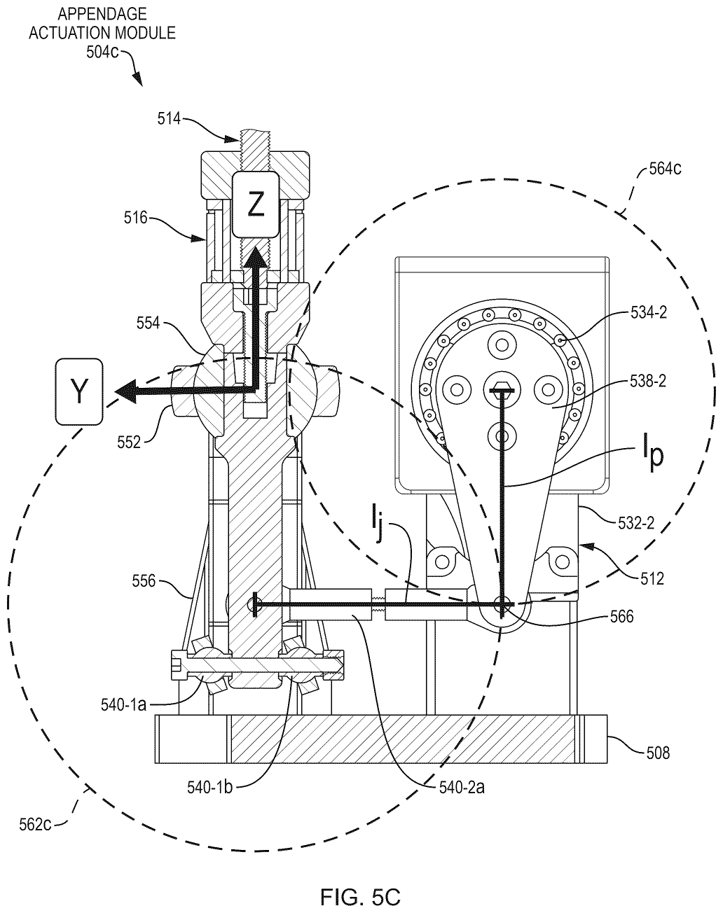

FIG. 5A is an isometric diagram of an example embodiment of a spherical interaction of an appendage actuation module 504a positioned in-frame with a reference frame 558. The appendage actuation module 504a may be similar to the appendage actuation module 204-2 of the system 202 in FIG. 2. Continuing with reference to FIG. 5A, the appendage actuation module may include an appendage 514, a platform 508, and rotation actuation devices 512-1, 512-2. The rotation actuation devices 512-1, 512-2 may include rotation actuators 532-1, 532-2, slop reducers 536-1, 536-2, horns 538-1, 538-2, and ball bearings 534-1, 534-2. The appendage 514 may include a sensor unit 516 and may be coupled mechanically with a spherical joint linkage 552, including a socket 553 and a spherical joint 554, configured to enable the appendage 514 to pivot around a point internal to the spherical joint linkage 552. The spherical joint linkage 552 may couple statically with the platform 508 through a rigid structure 556. The horn 538-1 of the rotation actuation device 512-1 may be coupled to the appendage 514 using at least one ball joint linkage 540-1a, 540-1b. Similarly, the horn 538-2 of the rotation actuation device 512-2 may be coupled to the appendage 514 using at least one ball joint linkage 540-2a, 540-2b.

For some embodiments of a system for manipulating deformable objects with multiple actuation devices, for example the appendage actuation module 504a, kinematics for controlling the appendage 514 may not fit within predefined frameworks for forward or inverse kinematics. For example, the Denavit-Hartenberg parameter formulation does not apply for the system 102, 202, as well as the appendage actuation platform 504a, due to the non-serial nature of the actuators of the system. For such systems, the inverse kinematic problem, which may need to be derived, may be formally defined as: given an XYZ position of a tip of the appendage, solving for rotation angles, for example, a yaw and a pitch angle, of the horns of the rotation actuation devices and a rotational position of the linear actuation device.

The motion of a multi-body structure including the appendage 514 and the rotation actuation devices 512-1, 512-2 may be modeled as a pivot about the spherical joint linkage 552. The spherical joint linkage 552 may be used to designate the reference frame 558, the reference frame 558 enabling the use of spherical coordinates by considering the appendage as an R-vector with a length of l_{c}, as shown in Table 1 for an example embodiment of a system for manipulating deformable objects. The reference frame 558 may define a pitch plane 560, for example, a YZ plane, and a yaw plane (not shown), for example, an XZ plane. Movement of the appendage 514 along the yaw plane (not shown) and the pitch plane 560 may be caused by the rotation actuation devices 512-1, 512-2.

Spherical angles Ψ and Φ may be used to represent the rotation of the appendage with respect to the spherical joint linkage 552. The spherical angles may be derived using EQNS. 1-4, in which X and Y may be a desired or known position of the appendage 514 with respect to the XYZ reference frame 558 and r is the projection of the R-vector in an XY plane of the reference frame 558 calculated using Ψ. dₚ may represent a vertical displacement of the entire platform 508.

$$Ψ = {tan}^{- 1} \frac{X}{Y} \qquad ( 1 )$$

$${z}_{c a l c} = \sqrt{{l}_{c}^{2} - {r}^{2}} \qquad ( 2 )$$

$$Φ = {cos}^{- 1} \frac{{z}_{c a l c}}{{l}_{c}} \qquad ( 3 )$$

$${d}_{p} = Z - {z}_{c a l c} - {z}_{offset} \qquad ( 4 )$$

FIG. 5B is a diagram of the reference frame 558 of FIG. 5A. Continuing with reference to FIG. 5B, the reference frame 558 indicates spherical angle Ψ 559, spherical angle Φ 561, R-vector 563, and projection r 565.

Returning to FIG. 5A, while spherical coordinates of the appendage 514 may be mapped to rotation angles of the horns 538-1, 538-2 of the rotation actuation devices 514-1, 514-2, a relation between the spherical coordinates and the rotation angles may not be linear, i.e., a linear motion of rotating the horns 538-1, 538-2 about two axes causes the appendage 514 to trace a spherical arc in 3D space, resulting in a loss of height proportional to the displacement from the Z-axis. Modeling the relation between the spherical coordinates and the rotation angles of the horns 538-1, 538-2 may start by considering an interaction between a single rotation actuation device, for example, the rotation actuation device 512-2, and a multi-body structure of the appendage 514 coupled mechanically to the rotation actuation devices 512-1, 512-2. An appendage-linkage sphere 562a with radius lⱼ may be defined with an origin at the linkage between the ball joint linkage 540-2a, 540-2b and the appendage 514 and a rotation-actuator sphere 564a with radius Is may be defined with an origin at a pivot of the rotation actuator 516.

FIG. 5C is a cross-sectional view of the spherical interaction of FIG. 5A, specifically the cross-section of the pitch plane 560, i.e., the YZ plane, from a perspective along the X-axis of reference frame 558 of FIG. 5A. Corresponding components between FIG. 5A and FIG. 5B are labeled using the same reference numbers. As rotational motion of the appendage 514 is constrained by the pivot of the spherical joint linkage 552 and the motion of the horn 538-2 of the rotation actuation device 512-2 is constrained to a rotation in a single plane, a plane of a sub-assembly, the sub-assembly including the spherical joint linkage 552, the horn 538-2, and the rotation actuation device 512-2, may be defined along the center of the horn 538-2, for example, the pitch plane 560. The plane may generate two circles, an appendage-linkage circle 562c at the intersection between the plane and the appendage-linkage sphere 562a and a rotation-actuator circle 564c at the intersection between the plane the rotation-actuator sphere 564a.

The appendage-linkage circle 562c and the rotation-actuator circle 564c intersect at intersection point 566, the intersection point 566 corresponding to the intersection of the horn 538-2 and the ball joint head buckle linkage 540-2a. The intersection point 566 represents a desired location of the horn, which may be solved for to obtain a desired rotation angle of the horn.

TABLE 1
Specifications of an embodiment of a system
for manipulating deformable objects

| Symbol | Description | Value |
|---|---|---|
| l_{c} | Length of chopstick [mm] | 162 |
| lᵢ | Length of ball-joint linkage [mm] | 32.5 |
| lₚ | Length of pitch servo horn [mm] | 28 |
| l_{y} | Length of yaw servo horn [mm] | 32 |

Respective locations of the two spheres may be found using the spherical coordinates and the reference frame 558 of the pivot. The position of the origin of the appendage-linkage sphere 562a may be computed as:

$${x}_{p o s} = - {l}_{b} sin ( Φ ) sin ( Ψ ) \qquad ( 5 )$$

$${y}_{p o s} = - {l}_{b} sin ( Φ ) cos ( Ψ ) \qquad ( 6 )$$

$${z}_{p o s} = - {l}_{b} cos ( Φ ) \qquad ( 7 )$$

where l_{b} is the distance from the reference frame, i.e., the pivot of the spherical linkage joint 552, to the connection point of the appendage to either of the rotation actuation devices. l_{b} may be lₚ for the connection point of the rotation actuation device 512-2 in the pitch plane or l_{y} for the connection point of the rotation actuation device 512-1 in the yaw plane.

When considering one of the rotation actuation devices, for example, the rotation actuation device 512-2 in the pitch plane, also referred to as the pitch rotation actuation device, motion is constrained to the YZ-plane of the reference frame 558 and the origin of the rotation-actuator sphere 562a is coincident with the axis of rotation of the pitch horn 538-2. When the appendage 514 moves around, the appendage-linkage sphere 562a may move out of the plane of interest, i.e., the pitch plane 560, meaning a circular-cross section between the appendage-linkage sphere 562a and the pitch plane 560, i.e., the appendage-linkage circle 562c, will change in radius and location.

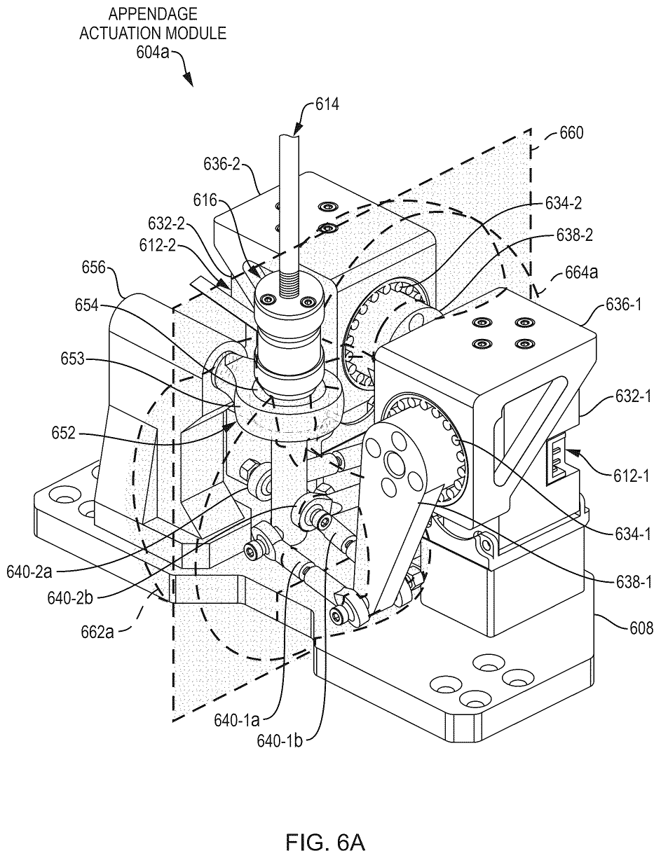

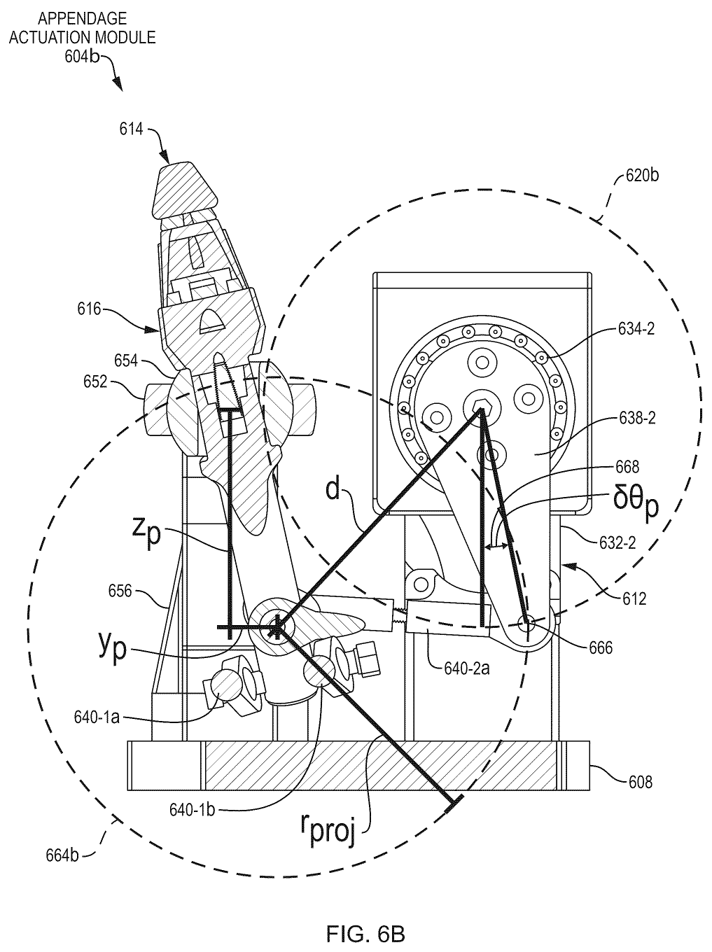

FIG. 6A is an isometric diagram of an example embodiment of a spherical interaction of an appendage actuation module 604a positioned out-of-plane with respect to a reference frame. The appendage actuation module 604a may be similar to the appendage actuation module 504a of FIG. 5A but oriented in a different position. Continuing with reference to FIG. 6A, the appendage actuation module 604a may include an appendage 614, a platform 608, and rotation actuation devices 612-1, 612-2. The rotation actuation devices 612-1, 612-2 may include rotation actuators 632-1, 632-2, slop reducers 636-1, 636-2, horns 638-1, 638-2, and ball bearings 634-1, 634-2. The appendage 614 may include a sensor unit 616 and may be coupled mechanically with a spherical joint linkage 652, including a socket 653 and a spherical joint 654, configured to enable the appendage 614 to pivot around a point internal to the spherical joint linkage 652. The spherical joint linkage 652 may couple statically with the platform 608 through a rigid structure 656. The horn 638-1 of the rotation actuation device 612-1 may be coupled to the appendage 614 using at least one ball joint linkage 640-1a, 640-1b. Similarly, the horn 638-2 of the rotation actuation device 612-2 may be coupled to the appendage 614 using at least one ball joint linkage 640-2a, 640-2b. Similar to FIG. 5A, FIG. 6A also indicates a pitch plane 660, an appendage-linkage sphere 662a, and a rotation-actuator sphere 664a. A reference frame of the appendage actuation module 604a may be similar or identical to the reference frame of the appendage actuation module 504a.

FIG. 6B is a cross-sectional view of the spherical interaction of FIG. 6A, specifically the cross-section of the pitch plane 660, i.e., the YZ plane, from a perspective along the X-axis of reference frame 558 of FIG. 5A. Corresponding components between FIG. 6A and FIG. 6B are labeled using the same reference numbers. The pitch plane 660 of FIG. 6A intersects with the appendage-linkage sphere 662a to generate an appendage-linkage circle 662b and with the rotation actuation sphere 664a to generate a rotation-actuator circle 664b. The appendage-linkage circle 662b and the rotation-actuator circle 664b intersect at intersection point 666, the intersection point 666 corresponding to the intersection of the horn 638-2 and the ball joint head buckle linkage 640-2a.

Combining x=0 as an equation of the pitch plane 660 with the general equation of a sphere describes the circular intersection of the pitch plane 660 and the appendage-linkage sphere 662a, and yields:

$${( y - {y}_{p} )}^{2} + {( z - {z}_{p} )}^{2} = \sqrt{{r}^{2} - {x}_{p}^{2}} \qquad ( 8 )$$

The right-hand side of Eqn. 8 is the projected radius rₚᵣₒⱼ and xₚ is the subtracted value for a from the equation of a sphere. b and c are yₚ and zₚ, respectively.

The intersection points of the appendage-linkage circle 662a and the rotation-actuator sphere 664a may be calculated by first finding a distance between the respective origins:

$$d = \sqrt{{( {h}_{1} - {h}_{2} )}^{2} - {( {v}_{1} - {v}_{2} )}^{2}} \qquad ( 9 )$$

In the above Eqn. 9, (h,v) correspond to horizontal and vertical coordinates of the respective circle centers. A horizontal distance between the center of one circle and a radical line of the two circles is a line that joins the two intersection points. This quantity is found by combining the equations of the two circles, i.e., the appendage-linkage circle 662b and the rotation-actuator circle 664b, and solving for a horizontal and vertical coordinate of the two intersection points, given by:

$$l = \frac{{r}_{1}^{2} - {r}_{2}^{2} + {d}^{2}}{2 d} \qquad ( 10 )$$

$$h = \pm \sqrt{{r}_{1}^{2} - {l}^{2}} \qquad ( 11 )$$

EQNS. 9-11 consider a general case of circular intersections. A pair of circular intersection points with respect to the reference frame, e.g., the reference frame 558 of FIG. 5A, of the appendage 614 may be computed by substituting the values for d, l, and h into horizontal and vertical positions for the pitch plane 660.

$$y = \frac{l}{d} ( {y}_{2} - {y}_{1} ) \pm \frac{h}{d} ( {z}_{2} - {z}_{1} ) + {y}_{1} \qquad ( 12 )$$

$$z = \frac{l}{d} ( {z}_{2} - {z}_{1} ) \pm \frac{h}{d} ( {y}_{2} - {y}_{1} ) + {z}_{1} \qquad ( 13 )$$

After filtering out the intersection point outside a max range of motion of the horn 638-2 of the rotation actuation device 612-2, a displacement angle may be determined for the rotation actuation device 612-2. For the calculated intersection points in the pitch and yaw planes (y,z) and (x,z), respectively, and the locations of the pitch and yaw actuator circles (yₚₛ, zₚₛ) and (Xys, Zys), respectively.

$${δ}_{p} = {tan}^{- 1} \frac{y - {y}_{p s}}{z - {z}_{p s}} \qquad ( 12 )$$

$${δ}_{y} = {tan}^{- 1} \frac{x - {x}_{y s}}{z - {z}_{y s}} \qquad ( 13 )$$

The calculations described above provide the positions of the horn 638-2 of the rotation actuation device 612-2 with respect to the position of the appendage 612 to compute δₚ 668. Additional similar calculations may be performed for each additional rotation actuation device, for example the rotation actuation device 612-1 in the yaw plane to compute δ_{y}.

### Validation of Kinematic Model

The positional accuracy of an example embodiment of a system for manipulating deformable objects may be validated by incorporating retroreflective markers on to an appendage. The retroreflective markers may be threaded directly onto a tip of the appendage and the appendage may be offset appropriately. Positions of the appendage, that is, the {x,y,z} locations of the tip of the appendage are observed with respect to a zero position of the tip. The appendage is commanded to move to 1,000 positions from a uniform distribution in a theoretical workspace of the appendage. In this embodiment, the workspace spans±40 mm along a X and Y axes and 35 mm a Z axis. Positions of the retroreflective markers may be observed using a motion capture system, e.g., an OptiTrack motion capture system, and correlated through ROS. Pose errors between positions commanded by the system and positions observed by the motion capture system are computed as the L₂-norm of the respective positions.

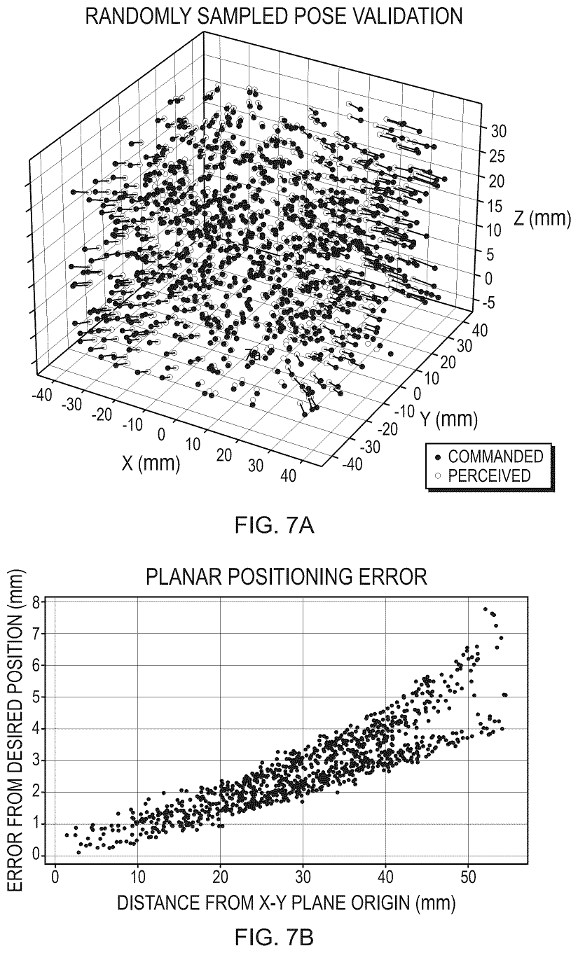

FIG. 7A is a plot of an example embodiment of positions commanded versus positions observed of an appendage of a system for manipulating deformable objects. Plotted are three-dimensional positions commanded by the system and positions observed by a motion capture system and retroreflective markers. The line joining points of the positions commanded and the positions observed indicate corresponding pairs.

FIG. 7B is a plot of pose error of the respective positions commanded versus positions observed of the appendage of FIG. 7A. Points in the plot represent the L₂-norm error between the corresponding positions commanded and positions observed of FIG. 7A, as indicated by the lines joining points. Further, when the chopstick is close to the Z-axis, the error may be minimal. Higher error may be present for the positions further displaced from an origin in an XY plane, as plotted along the X axis of FIG. 7B. The higher error may be caused by backlash of actuators and slop in mechanical linkage mechanisms. The overall distribution of errors along all axes may be minimal for objects of size≤20 mm, for example, many food items. A mean error in a corresponding workspace of ≤20 mm is less than 3 mm (Table 2). For example embodiments of a system for manipulating deformable objects with at least two appendages, the error may be even smaller towards the center point of the system between the at least two appendages. Minimized error in a grasping region may be desirable for actuating reliable, firm grasping positions. Larger errors at an edge of the workspace may be considered acceptable as larger strokes of an appendage at far extents of the workspace may be used for less precise actions, for example, pushing and orienting movements.

TABLE 2
Kinematic validation (pose error) for
an example embodiment of an appendage

| Mean (mm) | x (mm) | y (mm) | z (mm) |
|---|---|---|---|
| 2.93 ± 1.30 | 1.88 ± 1.10 | 1.79 ± 1.15 | 0.78 ± 0.61 |

### Validation of Force Feedback

In some example embodiments of a system for manipulating deformable objects, sensors may be coupled mechanically with appendages to detect forces applied to the appendages, for example, forces exerted on the appendages by a food item while grasping the food item. Sensitivity of the system to the forces applied may be evaluated by performing striking motions on objects of various shore hardness.

Objects may include platinum silicone rubbers (Smooth-On) of shore values of 00-40, 00-45, and 00-50 and may further include 3D-printed objects of shore hardness A-83 and A-95. The objects may be positioned directly between appendages in a gripping configuration and the appendages may be commanded to close to a zero position (fully grip). The object may then be released, and the process repeated.

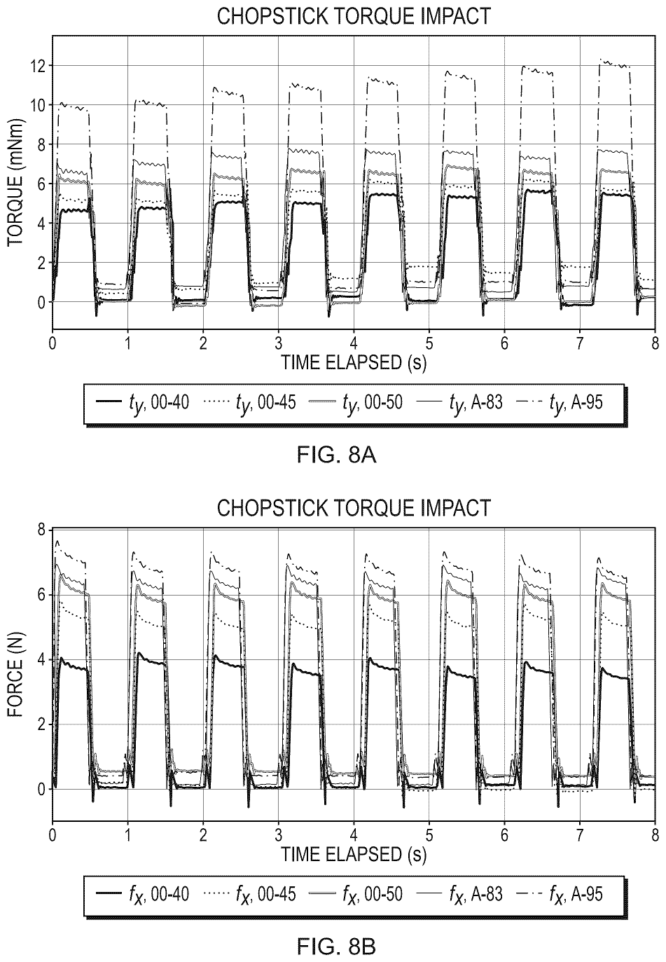

FIG. 8A is a plot of an example embodiment of force measurements from striking objects of varying shore hardness with an appendage, as described in the experiment above. Eight cycles of gripping are performed for of the aforementioned objects of different shore hardness. The force may be measured along an x-axis of a reference frame similar to the reference frame 558 of FIG. 5A.

FIG. 8B is a plot of an example embodiment of torque measurements from striking objects of varying shore hardness with an appendage, as described in the experiment above. Eight cycles of gripping are performed for of the aforementioned objects of different shore hardness. The plot of FIG. 8B is time synchronized with the plot of FIG. 8A. The torque measurements may be measured along a y-axis of a reference frame similar to the reference frame 558 of FIG. 5A.

In both the force readings of FIG. 8A and the torque readings of FIG. 8B, there is a clear distinction between materials of different shore hardness. Given a spanned range from soft (00-40) to firm (A-95), there is a noticeable increase in observed force along the applied axis as the appendage makes contact with the test object. Force increases are most pronounced in the softer objects (00-40, 00-45, 00-50). Differences between soft objects (≈2.5N) is more pronounced than differences between firmer objects (≈0.8N). These results show that the example embodiment of a system for manipulating deformable objects may have excellent sensitivity to distinguish between objects with small differences in hardness, for example, ripe or unripe fruit. This sensitivity to hardness may be consequential to manipulation strategies, e.g. pinch versus scooping or lifting.

### Grasping Experiments

As previously outlined, in some example embodiments of a system for manipulating deformable objects, the system may be used to grasp and manipulate, including rotate, food items. A capacity of the system to perform grasping and manipulating operations may be evaluated using a set of small, deformable food items. The system may be teleoperated into a repeatable grasping posed and the food items positioned with respect to the system. Appendages of the system may be actuated into a closed position around the food item and held in the closed position. The food items may be lifted 25 cm above the table and linearly translated 20 cm at 0.2 m/s for three cycles. The food items may further be rotated 90° around the Y and Z axes.

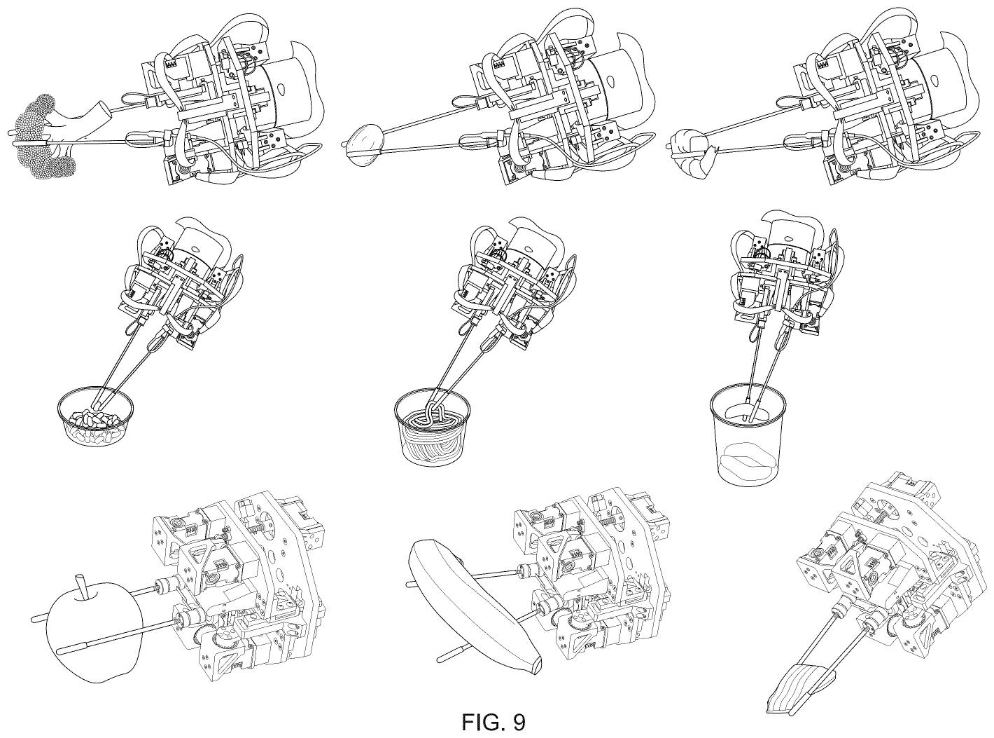

FIG. 9 is a compilation of example applications of a system for manipulating deformable objects, including a variety of food items, as described in the experiment above.

Table 3 discloses the results of experiment for grasping and rotating food items along with the weight and dimensions of the respective food items. If the food items remain grasped by the appendages during translation and rotation, respective cells for the food item of Table 3 are marked as success (Y). If the food items slip out of the grasp of the appendages or disintegrates at any point during the translation or the rotation, the respective cells of the food time of Table 3 are marked as failure (N).

TABLE 3
Parameters of food items and results of grasping trials

| Food | Weight (g) | Dim (mm) | Rotation | Linear |
|---|---|---|---|---|
| Sushi Roll | 25 | 35 × 45 × 25 | Y | Y |
| Frozen Scallop | 30 | 50 × 45 × 20 | N | N |
| Raw Scallop | 38 | 50 × 45 × 20 | Y | Y |
| Cooked Scallop | 25 | 40 × 35 × 25 | Y | Y |
| Grape | 9 | 28 × 18 × 24 | Y | Y |
| Edamame | <1 | 15 × 10 × 8 | Y | Y |
| Potsticker | 29 | 90 × 27 × 40 | Y | Y |
| Salmon Sashimi | 13 | 90 × 35 × 5 | Y | Y |
| Tuna Nigiri | 50 | 90 × 35 × 40 | N | N |
| Broccoli | 12 | 60 × 50 × 40 | Y | Y |
| Shrimp (small) | 7 | 48 × 35 × 14 | N | N |
| Shrimp (med) | 14 | 65 × 45 × 15 | N | Y |

The example embodiment of the system for manipulating deformable objects, including food items, performed well during a majority of trials. The nigiri slipped out during movement, which may be attributed to the grasp not being centered in a center of a heavy rice base of the nigiri and a piece of tuna on the nigiri was not secured. Grasping and transporting the nigiri may be improved by applying an agnel or orthogonal to a table under the nigiri. The frozen scallop may have been difficult to grasp due to the lubricity and rigidity of the frozen scallop. Otherwise, round or spherical objects normally considered to be unstable when grasped at two points were successfully secured during trials.

In additional embodiments, a method for manipulating deformable objects comprises causing at least one appendage, mechanically coupled to a baseplate, a platform, and at least one actuator, to move in at least three degrees-of-freedom, at least including an axis of linear translation and an axis of rotation, with respect to the baseplate. The method may further comprise positioning the at least one appendage to manipulate the deformable object along a plurality of degrees of motion, the plurality of degrees of motion at least including three axes of rotation.

Manipulating deformable objects may include grasping, pinching, rotating, scooping, lifting, or other operations. The method may further comprise concurrently transporting and manipulating the deformable objects.

The method may further comprise sensing properties of the appendage. The method may still further comprise operating the at least one actuation device based on the properties sensed in a closed feedback loop. The method may also further comprise grading the deformable objects based on the properties sensed, wherein grading includes evaluating the size, weight, hardness, or other characteristics of the deformable objects.

Positioning the at least one appendage may include computing a position of the at least one appendage based on the properties sensed using an inverse kinematic model for a plurality of actuators.

The method may further comprise positioning concurrently a plurality of appendages to manipulate the deformable object.

In further embodiments, a system for manipulating deformable objects may comprise means for enabling at least one appendage, mechanically coupled to a baseplate, a platform, and at least one actuator, to move in at least three degrees-of-freedom, at least including an axis of linear translation and an axis of rotation, with respect to a baseplate. The system may further comprise means for positioning the at least one appendage to manipulate the deformable object along a plurality of degrees of motion, the plurality of degrees of motion at least including three axes of rotation.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A system for manipulating deformable objects, the system comprising:
a baseplate;
at least one appendage actuation module configured to mount on the baseplate, the at least one appendage actuation module including an appendage of rigid and elongate construction, a platform, and at least one actuation device, the at least one actuation device in coupled arrangement with the appendage and the platform to cause the appendage to move in at least three degrees-of-freedom, at least including an axis of linear translation and an axis of rotation, with respect to the baseplate, the at least one appendage actuation module capable of actuating the appendage with sufficient force to manipulate deformable objects along a plurality of degrees of motion, the plurality of degrees of motion at least including three axes of rotation.

2. The system of claim 1, wherein the at least one actuation device includes a linear actuation device, a rotation actuation device, a spherical actuation device, another actuation device, or a combination thereof.

3. The system of claim 1, wherein the at least one actuation device is not more in number than a number of degrees-of-freedom of movement of the appendage with respect to the baseplate.

4. The system of claim 1, further including a spherical joint linkage statically coupled with the platform, wherein the appendage is coupled mechanically with the spherical joint linkage and the at least one actuation device may be configured to cause the appendage to pivot around a point internal to the spherical joint linkage.

5. The system of claim 4, wherein the at least one actuation device includes a rotation actuation device and a horn, the horn coupled mechanically with the rotation actuation device and configured to cause the appendage to pivot around the point internal to the spherical joint linkage, the horn and the appendage coupled mechanically using at least one ball joint linkage or ball head buckle linkage.

6. The system of claim 1, wherein at least a portion of the appendage is configured to be detachable.

7. The system of claim 1, wherein the baseplate further includes coupling members, the coupling members configured to mount the baseplate onto a mechanical, robotic, or biological apparatus.

8. The system of claim 1, further comprising at least one sensor configured to detect a corresponding property of the at least one appendage during operation.

9. The system of claim 8, wherein the at least one sensor includes a position sensor configured to detect a position state of the at least one actuation device during operation of the system.

10. The system of claim 8, wherein the at least one sensor includes a force-torque sensor, the force-torque sensor configured to couple mechanically with the appendage and to detect a force applied to the appendage.

11. The system of claim 8, further comprising a processor configured to compute a current position of the appendage and an end position of the appendage based on properties detected, to compute operations for the least one actuation device to move the appendage from the current position computed to the end position computed, and to cause the at least one actuation device to move the appendage based on the operations computed.

12. The system of claim 1, wherein the deformable object is a food item.

13. A method for manipulating deformable objects, the method comprising:
causing at least one appendage, mechanically coupled to a baseplate, a platform, and at least one actuation device, to move in at least three degrees-of-freedom, at least including an axis of linear translation and an axis of rotation, with respect to the baseplate; and
positioning the at least one appendage to manipulate the deformable object along a plurality of degrees of motion, the plurality of degrees of motion at least including three axes of rotation.

14. The method of claim 13, wherein manipulating includes grasping, pinching, rotating, scooping, lifting, or other operations.

15. The method of claim 14, further comprising concurrently transporting and manipulating the deformable objects.

16. The method of claim 13, further comprising sensing properties of the appendage.

17. The method of claim 16, further comprising operating the at least one actuation device based on the properties sensed in a closed feedback loop.

18. The method of claim 16, further comprising grading the deformable objects based on the properties sensed, wherein grading includes evaluating the size, weight, hardness, or other characteristics of the deformable objects.

19. The method of claim 16, wherein positioning the at least one appendage includes computing a position of the at least one appendage based on the properties sensed using an inverse kinematic model for a plurality of actuation devices.

20. The method of claim 13, further comprising positioning concurrently a plurality of appendages to manipulate the deformable object.

21. A system for manipulating deformable objects, comprising:
means for enabling at least one appendage, mechanically coupled to a baseplate, a platform, and at least one actuation device, to move in at least three degrees-of-freedom, at least including an axis of linear translation and an axis of rotation, with respect to a baseplate; and
means for positioning the at least one appendage to manipulate the deformable object along a plurality of degrees of motion, the plurality of degrees of motion at least including three axes of rotation.
